(19) United States
(12) Patent Application Publication
(10) Pub. No.: US 2011/0055894 A1
(43) Pub. Date: Mar. 3, 2011

(54) Firewall and NAT Traversal for Social Networking and/or Content Sharing On Mobile Devices

(76) Inventors: Shen-Chang Chao, Hong Kong (HK); Edward Lor, Hong Kong (HK); King Wai Chow, Hong Kong (HK); Vincent Wong, Hong Kong (HK); Karen Leung, Hong Kong (HK)

(21) Appl. No.: 12/551,279

(22) Filed: Aug. 31, 2009

(51) Int. Cl. G06F 15/16; G06F 21/00

(52) U.S. Cl. 726/3; 709/227

(57) ABSTRACT

A method for facilitating firewall and NAT traversal during social networking and/or content sharing via a mobile device uses an instant message protocol to establish a near real-time communications session between two user devices on opposite sides of the firewall or NAT enabled router. A first application on a mobile device provides social networking and/or content sharing. A second application on the mobile device establishes a communication session for exchanging near real-time messages between the mobile device and a second device over the firewall or NAT protected network. The second application is associated with the first application and allows the mobile device to access a file associated with the first application that is stored in the second device via the communication session.

### BACKGROUND TO THE INVENTION

1. Field of the Invention

The current invention relates to social networking via a mobile device and also to a content sharing via a mobile device. More particularly, the invention relates to traversal of network firewalls and/or network address translation (NAT) enabled routers for facilitating social networking and/or content sharing via a mobile device.

2. Background Information

The so-called web 2 phenomenon has sparked an increase in demand for information sharing and collaboration between individuals. The internet has become an integral part of everyday life with many people now being members of some form of web based service, web forum or on-line community which allows them to interact with others. On the back of this people have developed a need and desire to share information, pictures, video, comments and other electronic based content with others on an everyday basis. A user may have content spread across several different social networking sites, such as Facebook, Flickr and Picassa, as well as personal electronic devices such as a network capable mobile phone (e.g. a so called smartphone) or other mobile device, a home PC, IP-television top set box and internet enabled personal video recorder. Increasingly, users want to share or market their sharable content to others anywhere and anytime.

One of the problems associated with social networking and content sharing between mobile devices, in particular smartphones, is the traversal of firewalls, network address translation (NAT) enabled routers, and 3G and other cellular-type networks that only allow a connection, such as a Transmission Control Protocol (TCP) session, between a program on one internet connected device and another program on another internet connected device if the session is initiated internally to the network. That is to say, connection requests that are initiated from outside of a NAT/firewall protected network or 3G network are not passed on to the intended recipient. This means that a user/device located in or behind NAT/firewall protected network or 3G network cannot receive social networking messages or content sharing requests from outside the network unless they first initiate connection with the other party.

### SUMMARY OF THE INVENTION

Further aspects of the invention will become apparent from the following description, which is given by way of example only.

A method for facilitating firewall and NAT traversal during social networking and/or content sharing via a mobile device uses an instant message protocol to establish a near real-time communications session between two user devices on opposite sides of the firewall or NAT enabled router. In a particular aspect the invention provides a first application on a mobile device that provides social networking and/or content sharing services. A second application is also provided on the mobile device for establishing a communication session for exchanging near real-time messages between the mobile device and a second device over a network. The second application is associated with the first application and allows the mobile device to access a file associated with the first application that is stored in the second device via the communication session.

The forgoing is not meant to limit the scope of use or functionality of the invention and further aspects and features of the invention will become apparent from the following description which is given by way of example only.

### BRIEF DESCRIPTION OF THE DRAWINGS

An exemplary form of the present invention will now be described by way of example only and with reference to the accompanying drawings, in which:

FIG. 1 is a schematic illustration of a mobile device on which the current invention may be implemented,

FIG. 2 is a schematic illustration of a instant Messaging (IM) system,

FIG. 3 is a schematic illustration of a one example of an IM Client architecture for implementing the invention on a mobile device, and

FIG. 4 is a schematic flow diagram of a procedure for establishing IM sessions with peer users/devices for social networking interactions and/or content sharing.

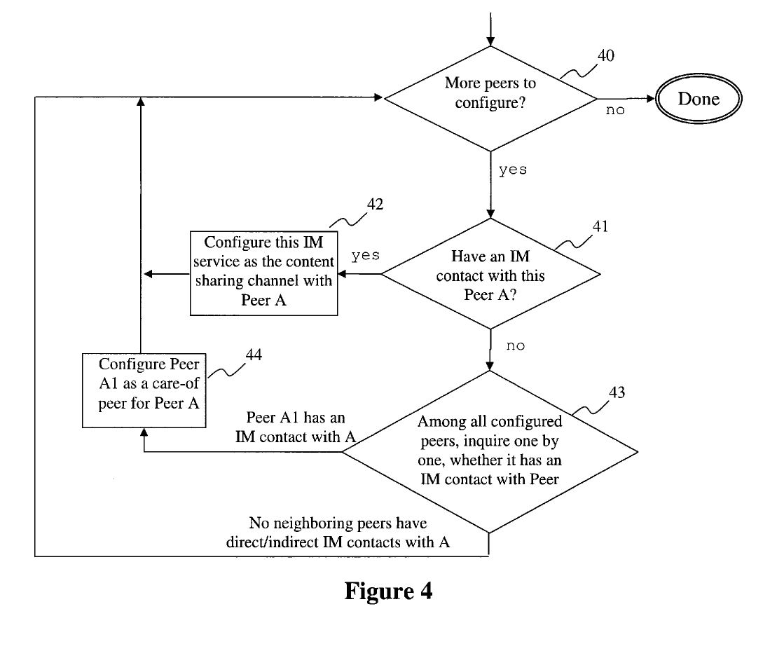

### DESCRIPTION OF THE EXEMPLARY EMBODIMENTS

Before any embodiments of the invention are explained in detail, it is to be understood that the invention is not limited in its application to the details or arrangements set forth in the following description or illustrated in the drawings. The invention is capable of other embodiments and of being practiced or of being carried out in various ways. Also, it is to be understood that the phraseology and terminology used is for the purpose of description only and should not be regarded as limiting.

One or more of the inventors has already proposed a device and method for participating in a peer-to-peer network is application Ser. No. 12/059,787 filed on 31 Mar. 2008 and a method and device for providing offline web services filed as U.S. application Ser. No. 12/335,215 on 15 Dec. 2008. The entire contents of both of said application Ser. Nos. 12/059,787 and 12/335,215 are incorporated herein by reference. These two applications provide for a device and method for forming offline peer 2 peer networks and for content sharing between two or more neighboring devices belong to the same user located in different locations. One or more of the inventors has also proposed a device and method for content sharing on mobile devices for which an application for a US patent has also been filed. Details of this later device and method are discussed below to aid illustration of the current invention. These other methods and devices are complementary to the current invention and, although not critical to the current invention, may be implemented together with the current invention in a single mobile device.

In the current invention it is proposed to overcome problem of NAT/firewall protected networks or 3G networks or WiFi hotspots by using an instant messaging (IM) platform for communication between peers in a social networking/content sharing group. In the following description reference to instant messaging (IM) refers to a near real-time communication platform between two or more network or Internet based user/devices based on typed text. There are many popular IM service, such as Windows Live Messenger, Yahoo Messenger, AOL Instant Messenger, which each boast hundreds of millions of registered users and user connections each month. Most Internet based IM services provide means for NAT/firewall traversal, together with file transfer and increasingly video and voice services. It is proposed by the current invention that social networking and content sharing interactions within a contact/friends group piggyback on an IM service to traverse NAT/firewalls and 3G networks. Such social networking and content sharing interactions include, but are not limited to various requests and responses, messages and file transfers. Interaction between parties can be either as text in the body of an IM or through file transfer or other data exchange mechanisms provided with IM clients/services. Whilst the transfer of any data other than text in the body of an instant message can be slow it is envisaged that only a small size messages and content sharing lists would be transmitted via IM with the receiving party being able to initiate direct requests to the content source for download/transfer of the actual content.

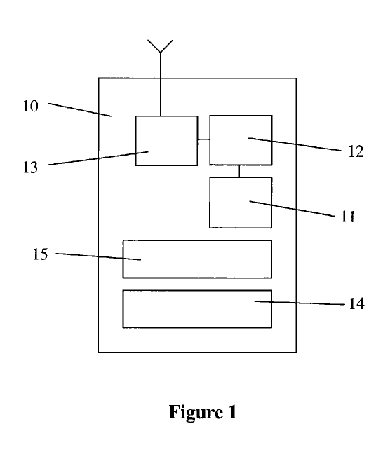

In the preferred embodiment of the invention an instant message (IM) client is implemented in a smartphone like that schematically illustrated in FIG. 1. The smartphone 10 has a memory 11, a processor 12, a wireless radio module 13 and user interface means in the form of a keypad 14 and screen 15. This is not however intended to limit the scope of use of the invention and it will be evident to skilled addressees that the invention can be implemented in any mobile device such as a Smartphone, PDA, netbook or laptop-type device. The IM client can be implemented using a third party application or software module which can be installed in the device memory and run by the processor of the mobile device to provide an instant messaging client. Development of third party applications for mobile devices is commonplace as is instant messaging applications, and the development of such applications for implementation of the invention will be readily apparent and pose no difficulty to one of ordinary skilled in the art. In an alternative embodiment of the invention and it is envisaged that the invention is implement thought firmware built directly into a mobile device by the device vendor.

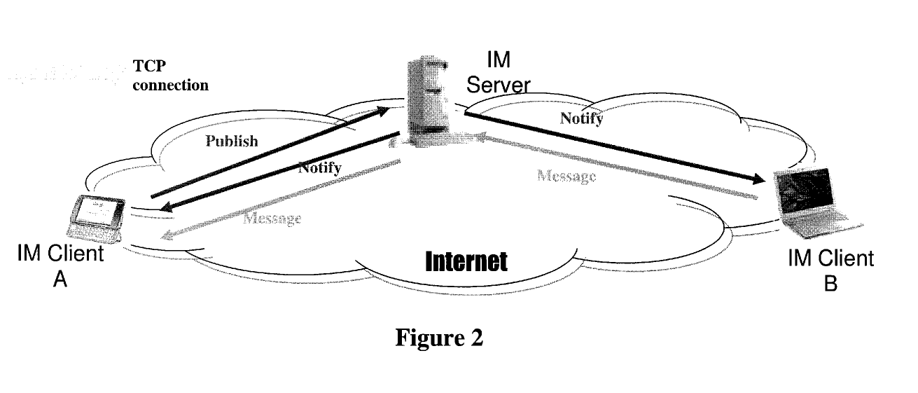

FIG. 2 illustrates a basic overview of an instant messaging service at can be used by the invention. Some IM applications use a peer-to-peer protocol while others required peers to connect and communicate through a server. In order to achieve NAT/Firewall traversal an IM service utilizing a server as illustrated in FIG. 2 is preferred. In FIG. 2 and first user, IM client A, can communicate with a second user, IM client B, through an IM server. Either party must be registered with an IM server. When either party connects its device to the Internet the device registers its presence with the IM server, which publishes its presence. When a second user logs on and registers with the IM service both users are able to see the presence of each other if they are part of the same contact groups. Either user may then initiate a request to the other party via the IM server without problems of NAT/firewall blocking, because the TCP connections between the server and each client was initiated from the client end. The specific detail of IM protocols and requirements is well within the understanding and capability of the skilled addressee. It is envisaged that social network and content sharing interactions between parties that can be effectively transmitted as text messages such as invitations and responses to join groups, requests for content lists, request to search for content and textual content itself, can be sent as instant messages between peers. Other social networking and content sharing exchanges such as file based content lists, search results and multi-media content (e.g. voice, photos, video and the like) can be sent as file transfers via instant messaging if necessary or if available by the receiving end initiating a direct TCP connection with the content source.

It is envisaged that within a particular user's list of contacts/friends many or most will be registered users of a particular IM service. If both or all friends wishing to engage in mobile social networking or share content are members of the same instant messaging service, for example Windows Live Messenger, Yahoo Messenger, AOL Instant Messenger or the like, then they can exchange content information using the respective IM service overlay. If there is no common public IM service or interface then one or more other contacts/friends may be needed to contact to peers. For example, if a user 1 and 2 both have Windows Live Messenger accounts and users 2 and 3 have AOL Instant Messenger accounts then users 1 and 3 can communicate using an instant messaging interface using user 2 as an intermediary for relaying messages. A limit may be needed on the number of intermediaries for two peers to connect, but this is implementation specific. If a particular user does not have a common IM account with anyone else in a contact/friends list then that user simply cannot participate in a content sharing network. However, most instant messaging accounts are free and it is envisaged that users will join a particular services, or even multiple IM services, depending on those that their contacts/friends belong to if for no other reason then to provide a platform for this type of content sharing.

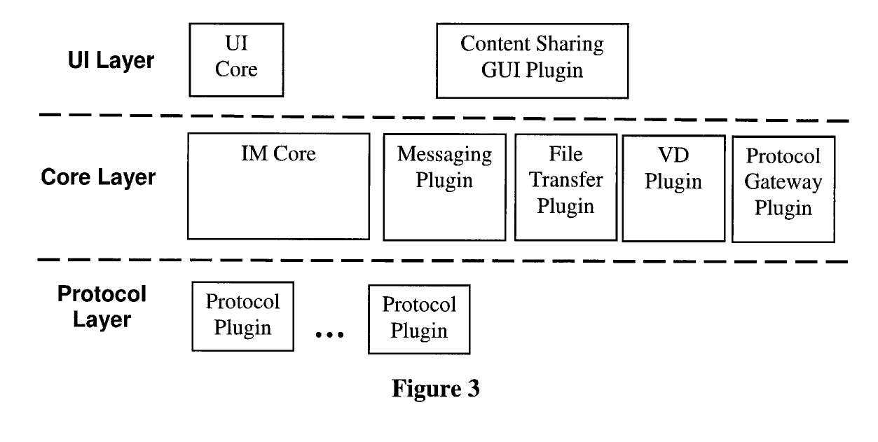

FIG. 3 illustrates a preferred architecture for an instant messaging client for a mobile device that can connect with different instant messaging services (protocols) for implementation of the invention and in particular for a relaying of messages between users on different IM services if necessary. The architecture has three layers, namely a user interface layer, a core layer and a protocol layer. The user interface layer provides the user interface for the mobile device and may include a user interface core and various user interface plug-ins for different instant messaging clients. At the core layer are modules for providing features for the instant messaging client for example messaging, file transfer, VoIP etc. Finally at the protocol layer there are protocol plug-ins for communication using the different instant messaging protocol, for example Windows Live Messenger, Yahoo Messenger, AOL Instant Messenger, XMPP etc.

FIG. 3 illustrates a block diagram implementation of a preferred embodiment for setting up instant messaging connections for social networking interactions and/or content sharing according to the invention. In decision block 41 a decision is made on whether to configure an IM connection with a peer contact in the contact/friends list. If there are no peers to configure in the list then the method ends. If there are more peers to configure then function flow moves to decision block 41 where it is decided whether there is a shared IM contact with a particular peer, say peer A, (i.e. is peer A also a contact in the IM service to which the user belongs). If so, then process block 42 configures the IM service as a social networking/contact sharing communication channel with a peer A. If the decision is no then function flow moves to a third decision block 43 which requests information from each other contact/friend as to whether that peer has an IM service contact with peer A. If a positive answer is found then in process block 44 peer A is configured as in the care of a third party contact for relaying of IM messages between services. If no common contact is found then peer A cannot participate in instant messaging contact sharing.

It envisaged that the current invention can be implemented in a device or for social networking/content sharing interactions provided in application Ser. Nos. 12/059,787 and 12/335,215 or co-pending application for a device and method for content sharing on mobile devices. In the device and method for content sharing on mobile devices a user creates and stores an aggregated list of all sharable content on their mobile device. The content may be spread across several different social networking sites, such as Facebook, Flickr, Picassa, or in a network capable mobile phone (Smartphone) or other mobile device, a home PC, IP-television top set box internet enabled personal video recorder. The list could be in the form of a simple text file or other list structures know in the art. The mobile device containing the list, or virtual directory, of a user's content becomes a content management device. The user can publish or advertise their content by sending the virtual directory to other users using instant messaging via the internet for an internet connected Smartphone for example, or by making the list available to other users who make a request via instant messaging to the mobile device containing the list.

The mobile device also contains a contact or friends list having details of other people or devices with which the mobile device can share the content sharing list. Such contacts can be imported from content/friend lists in other devices, applications or on-line communities such as mobile devices, PCs, Facebook friends, linked in and IM services such as Windows Live Messenger, Yahoo Messenger, AOL Instant Messenger and the like. Such imported contacts can be organized into groups or individuals with different content viewing rights. Items within the virtual directory are contact lists and are associated with one or more groups or individual of contacts who are authorized to view and share the content. In this way a user can control which contacts/friends can view and access certain content. Users are accessing or viewing a virtual directory content list only have access to those content items and folders authorized by their group or contact association. The contact/friends list can also be used to establish IM connections according to the method of FIG. 3.

What is claimed is:

1. A method for facilitating firewall and NAT traversal during social networking and/or content sharing via a mobile device comprising:
providing a first application for providing social networking and/or content sharing in a mobile device, and
providing a second application for establishing a communication session for exchanging near real-time messages between the mobile device and a second device over a network, wherein the second application is associated with the first application and allows the mobile device to access a file associated with the first application that is stored in the second device via the communication session.

2. The method of claim 1 wherein allowing access a file stored in the second device comprises displaying at least part of the file contents on the first device.

3. The method of claim 1 wherein establishing a communication session for exchanging near real-time messages comprises authenticating a contact associated with the second device.

4. The method of claim 1 wherein the second application is arranged to establish the communication session via a server that provides near real-time messages between two or more devices.

5. The method of claim 1 wherein the second application is adapted to establish a second communication session for exchanging near real-time messages between the mobile device and a third device over a network, wherein the second application allows the second device to access a file associated with the first application that is stored in the third device via the communication session.

6. The method of claim 1 wherein the session for exchanging near real-time messages is a text based instant message session.

7. The method of claim 1 wherein the session for exchanging near real-time messages is a file transfer session.

8. A mobile device for facilitating firewall and NAT traversal during social networking and/or content sharing using the mobiledevice, the device comprising:
a first application for providing social networking and/or content sharing in a mobile device, and
a second application for establishing a communication session for exchanging near real-time messages between the mobile device and a second device over a network, wherein the second application is associated with the first application and allows the mobile device to access a file associated with the first application that is stored in the second device via the communication session.

9. The mobile device of claim 8 wherein the second application is programmed to display the file stored in the second device on the first device.

10. The mobile device of claim 8 wherein the second application is programmed to establish the communication session via a server that provides near real-time messages between two or more devices.

11. The mobile device of claim 8 wherein the second application is programmed to establish a second communication session for exchanging near real-time messages between the mobile device and a third device over a network, wherein the second application allows the second device to access a file associated with the first application that is stored in the third device via the communication session.

12. The mobile device of claim 8 wherein the session for exchanging near real-time messages is a text based instant message session.

13. The mobile device of claim 8 wherein the session for exchanging near real-time messages is a file transfer session.
